(19) United States
(12) Patent Application Publication
(10) Pub. No.: US 2026/0030352 A1
(43) Pub. Date: Jan. 29, 2026

(54) METHOD OF DETECTING HACKER ATTACKS AND CORRESPONDING INTEGRATED CIRCUIT PACKAGE

(71) Applicant: STMicroelectronics International N.V., Geneva (SL)

(72) Inventors: Antonino MONDELLO, Messina (IT); Riccardo CONDORELLI, Tremestrieri Etneo/Catania (IT)

(73) Assignee: STMicroelectronics International N.V., Geneva (CH)

(21) Appl. No.: 19/276,569

(22) Filed: Jul. 22, 2025

(30) Foreign Application Priority Data
Jul. 26, 2024 (IT) 102024000017470

(51) Int. Cl. G06F 21/55; G06F 21/81

(52) U.S. Cl. CPC G06F 21/554; G06F 21/81; G06F 2221/034

(57) ABSTRACT

Hacker attacks that involve stimulating voltage variations in an integrated circuit package are detected by deploying a network of elementary detectors distributed across the integrated circuit package. Each detector is positioned at a respective location within the package and is configured to generate an alarm signal in response to a voltage variation occurring at that specific location. The elementary detectors include a first component and a second component (such as flip-flops) with respective outputs configured to be set to complementary binary levels. Logic circuitry is coupled to the outputs of the first and second components and is designed to generate an alarm signal when the outputs of the first and second components no longer exhibit complementary binary levels, indicating a hacker attack involving a localized voltage variation within the integrated circuit package.

### PRIORITY CLAIM

This application claims the priority benefit of Italian Application for Patent No. 102024000017470, filed on Jul. 26, 2024, the content of which is hereby incorporated by reference in its entirety to the maximum extent allowable by law.

### TECHNICAL FIELD

The present description relates to the detection of hacker attacks.

Aspects of the present description can be used, for instance, in defending system-on-chip architectures against physical hacker attacks by applying run-time countermeasures aiming at blocking attacks.

### BACKGROUND

Detecting “physical” hacker attacks is a subject of continuous development.

Effectively detecting hacker attacks facilitates the application of run-time countermeasures to block attacks, such as new-generation attacks where a hacker locally modifies the supply of a chip.

Most physical hacker attacks are based on attempts to modify the voltage value of a chip. Such modifications may occur locally, allowing the functionality of the chip to be maintained, except for a portion (“sub-circuit”) where sensitive information is stored or sensitive checks are performed.

Such localized modification may involve inducing a variation (“bounce”) of a voltage value in the chip from outside the chip, in some cases without removing a part of the package or opening the package (so-called decapping).

For example, a local supply can be modified in various ways.

For instance, attackers may attempt to change the level of one of the supply lines, and may apply μ-probing techniques together with focused ion beam (FIB).

An electromagnetic (EM) field (leading to a so-called Local EM Attack, LEMA) or laser beam energy (leading to a so-called Laser Fault Injection Attack, LFIA) can be applied within the framework of attacks that affect functioning of sub-parts of a circuit.

### SUMMARY

An object of one or more embodiments is to contribute to addressing the issues discussed above.

According to one or more embodiments, such an object can be achieved via a method having the features set forth in the claims that follow.

One or more embodiments relate to a corresponding integrated circuit package. A system-on-chip (SoC) is exemplary of such a package.

In solutions as described herein, a user (customer) can be provided with, possibly configurable, hardware (HW) tools configured to detect hacker attacks with a view to countering them.

In solutions as described herein, a (very) high number of detectors (sensors) are distributed according to a coordinate policy over an integrated circuit (IC) package intended to be protected. These sensors can detect the effects of an external entity that can cause malfunctioning (i.e., flipping of flip-flops (FFs)) of the circuit.

In solutions as described herein, Nested vector interrupt control (NVIC) can be used to facilitate the sophisticated management of interrupts (and thus counter attacks).

For instance, in response to a host decision, some interrupts can be disabled, while others are addressed with a (high) priority in view of the importance of the circuit protected in a particular application.

Detectors as discussed herein can include different types of flip-flops, according to the sensitivity requirements and the area where such detectors are to be placed: for instance, sensors distributed over a certain area can use the same type of flip-flops as those used in the protected area.

Different strategies can underlie placing the detectors.

For instance, the sensors can be: distributed in a homogenous way within the area of the chip, located in the area where flip-flops are located, or distributed as deemed more advantageous by a designer/user.

Solutions as described herein may offer one or more of the following advantages: no specific setup from a host is involved; the solutions proposed herein do not rely on IP modifications and are thus ultimately “IP agnostic”: this is particularly advantageous in those cases where system features are intended to be specified by a third party; and the solutions proposed herein can be applied to SoC architecture a posteriori (that is, once a design is already consolidated).

### BRIEF DESCRIPTION OF THE DRAWINGS

One or more embodiments will now be described, by way of example only, with reference to the annexed figures, wherein:

FIG. 1 is a general presentation of an approach underlying solutions as described herein;

FIG. 2 is a circuit diagram of a detector suited for use in solutions as described herein;

FIG. 3 is a diagram exemplary of a first possible implementation of solutions as described herein;

FIG. 4 is a diagram illustrative of a possible time behavior (waveform) of a signal that may occur in a system as exemplified in FIG. 3;

FIG. 5 is a circuit diagram illustrating possible implementation details of a solution as illustrated in FIG. 3;

FIG. 6 and FIG. 7 are block diagrams of other possible implementations of solutions as described herein;

FIG. 8 illustrates a possible option in implementing solutions as described herein;

FIG. 9 is a block diagram of multicore system-on-chip (SoC) architecture wherein solutions as described herein can be applied;

FIG. 10 is a detail of a possible implementation of solutions as described herein; and

FIGS. 11A, 11B, and 11C illustrate possible alternative options in implementing the detector presented in FIG. 2.

### DETAILED DESCRIPTION

The figures are provided to clearly illustrate the relevant aspects of the embodiments and are not necessarily drawn to scale.

The edges of features drawn in the figures do not necessarily indicate the termination of the extent of the feature.

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures annexed herein, unless the context indicates otherwise, like parts or elements are indicated with like references/numerals and a corresponding description will not be repeated for the sake of brevity.

Once more, for the sake of simplicity and ease of explanation: a same designation may be applied throughout this description to designate a certain node or line as well as a signal occurring at that node or line; and a same designation may be applied throughout this description to designate certain components (such as a capacitor, resistor or inductor or coil) as well as electrical parameters thereof.

Also, when it is mentioned that an element is “connected to” or “coupled to” another element, it should be understood that yet another element may be interposed therebetween, as well as that the element may be connected or coupled directly to another element.

By way of example, in various figures annexed to the present description such as FIG. 2, a possible embodiment of an elementary detector is illustrated wherein an OR gate is coupled to an output (neg(Q)) from a first flip-flop via a logic inverter interposed therebetween.

Hacking techniques are extensively discussed in the literature, as evidenced, for instance, by documents (all incorporated herein by reference) such as:
Rodriguez, et al.: “LLFI: Lateral Laser Fault Injection Attack, 2019 Workshop on Fault Diagnosis and Tolerance in Cryptography (FDTC), Atlanta, GA, USA, 2019, pp. 41-47;
Leveugle, et al.: “Experimental Evaluation of Protections Against Laser-induced Faults and Consequences on Fault Modeling”, 2007 Design, Automation & Test in Europe Conference & Exhibition, Nice, France, 2007, pp. 1-6; or
Bar-El, et al.: “The Sorcerer's Apprentice Guide to Fault Attacks,” Proceedings of the IEEE, vol. 94, no. 2, pp. 370-382, February 2006.

Other prior art documents include US 2008/0059741 A1, US 2012/0226845 A1, U.S. Pat. No. 11,620,178 B1, U.S. Pat. No. 7,805,557 B2, and U.S. Pat. No. 7,590,880 B1 (all incorporated herein by reference).

As discussed, “physical” attacks by hackers are oftentimes based on an attempt to hack a voltage value of the chip: this may occur locally, with chip functionality otherwise maintained with the sole exception of a portion (“sub-circuit”) where, for instance, sensitive information is contained or where sensitive checks are performed.

Such a localized hacking of a voltage value of the chip can involve a variation (“bounce”) induced in various ways from outside the chip: a variation in outside supply lines and/or a variation induced via μ-probing techniques, focused ion beam (FIB), electromagnetic (EM) fields, or laser beams applied are exemplary of hacking attacks that may take place without removing a part of the package or opening the package (so-called decapping).

For instance, attackers may use a miniaturized micro antenna (μEM probe) positioned over an integrated circuit (IC) chip and a local electromagnetic attack (LEMA) can be attempted as a side-channel attack by relying on the fact that motion or even static placement of such an antenna over the chip can create a change in the electromagnetic field in the vicinity of the IC chip.

As a further example, a laser fault injection attack (LFIA) can be attempted by relying on the fact that, in response to irradiation with a laser beam, electron-hole pairs are induced in an IC due to the interaction with photons. This affects transistors biased by power supply and ground voltages applied to the IC by creating a flow of substrate current and an associated voltage “bounce” at the location of irradiation.

Nagata, et al.: “On-Chip Physical Attack Protection Circuits for Hardware Security”, IEEE Custom Integrated Circuits Conference 2019, Invited Paper, 1-6 (incorporated herein by reference) provides further details on this topic.

Also, Courbon, et al: “Adjusting laser injections for fully controlled faults”, in Constructive Side-Channel Analysis and Secure Design 2014, April 2014, Paris, France (incorporated herein by reference) details various effects observed depending on levels of energy hitting the backside of a circuit.

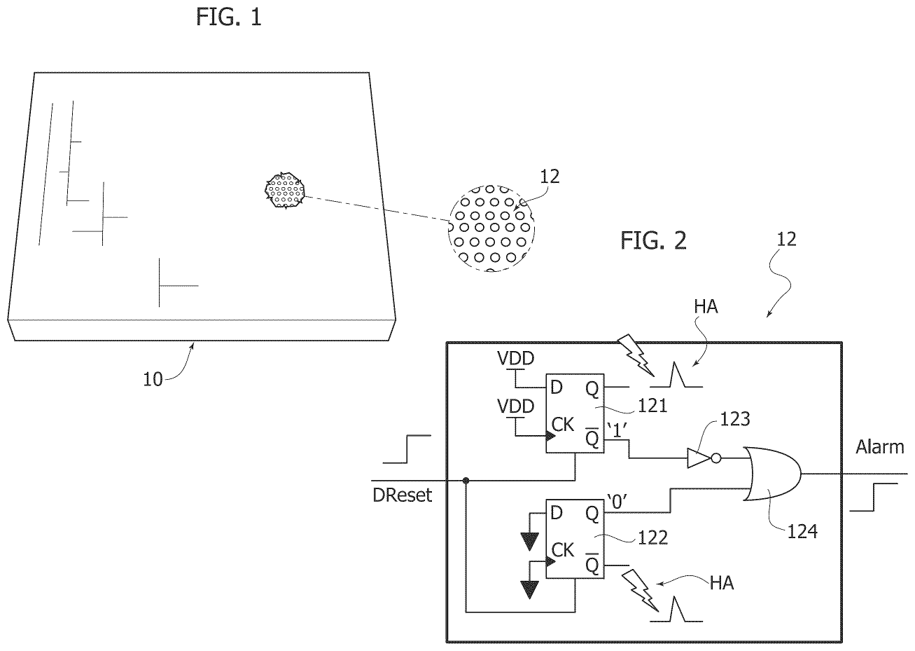

FIG. 1 illustrates a general concept underlying solutions as described herein, namely, disseminating over—at least one portion of—an integrated circuit 10 (this may be a semiconductor chip or die of whatever type: as noted, solutions as described herein can be regarded as “IP agnostic”) a high number (notionally thousands) of elementary detectors 12.

These detectors (sensors) are configured to detect the effect of an external disturbance that may cause malfunctioning (flip-flop flipping, as a possible example) in the chip or die 10.

The terms chip and die are used herein as synonymous.

To summarize, solutions as described herein are intended for detecting hardware hacker attacks wherein voltage variations are stimulated in an integrated circuit package 10.

To that effect, according to solutions as described herein, a network of elementary detectors 12 are distributed over the integrated circuit package 10, with each detector 12 arranged at a respective location of the integrated circuit package 10.

The detectors 12 are configured to produce an alarm signal in response to a voltage variation occurring (that is, being stimulated in response to a localized hacker attack) at the location of the integrated circuit package 10 where a sensor is arranged.

The specific nature of the detectors/sensors 12 is not per se critical, provided certain factors are taken into account.

For instance, using a large number (thousands) of detectors 12 is facilitated by: using small circuits (few logic gates, few flip-flops, FFs); applying standard CMOS technology, which is advantageous for placement and routing purposes also for sea-of-gates architectures with a standard flow; adopting a simple routing (which can be managed with just a few wires); providing solutions that can be made available for hosts without appreciable setup involved; low power consumption; and applicability at system-on-chip (SoC) level, so that no modifications of IPs/subsystems are involved (these modifications may turn out to be critical when IPs from third parties come into play).

FIG. 2 is a representation of an (elementary) detector 12 that provides such desirable features by including just two flip-flops 121, 122 that receive a common reset signal DReset and have respective outputs—neg(Q) and Q, respectively—coupled to: a logic inverter 123 in turn coupled to one of the inputs of an OR gate 124, and the other input of the OR gate 124, whose output provides a warning signal Alarm in response to a hacker attack HA (LEMA or LFIA, for instance, here represented as a voltage “bounce”) likely to result in “flipping” of the flip-flop 121 and/or the flip-flop 122.

It is noted that the D-type FFs 121, 122 are shown in FIG. 2 with their D inputs coupled to a supply node/line VDD. Other possible (static) configurations of these FFs may include coupling the D inputs to ground (GND), which facilitates increasing the sensitivity to any possible disturbance on VDD or GND. The same also applies to the other types of FFs discussed in the following in connection with FIGS. 11A, 11B and 11C.

The solution of FIG. 2 is thus exemplary of an elementary detector 12 comprising: a first component (the flip-flop 121) and a second component (the flip-flop 122) having respective outputs Q, neg(Q) that are configured to be set (via the line DReset) to first logic levels (binary levels such as “1” and “0”, for instance), and logic circuitry (the inverter 123 and the OR gate 124) that is coupled to the respective outputs Q, neg(Q) of the first component 121 and the second component 122.

That logic circuitry is thus configured to produce an alarm signal Alarm in response to a change in at least one of the first logic levels at the outputs Q, neg(Q) of the first and second components 121,122.

In fact, with—by way of example—first values neg(Q)=1 and Q=0 the two inputs to the OR gate 124 (namely neg(Q) from the flip-flop 121, logically inverted to “0”, and Q from the flip-flop 122, which is set to “0”) cause the output from the OR gate 124 to be “0” (no alarm).

If at least one (namely either one or both) of the outputs Q, neg(Q) is caused to change, that is neg(Q) changes from 1 to 0 and/or Q changes from 0 to 1, the output from the OR gate 124 switches to “1”, with the signal Alarm issued.

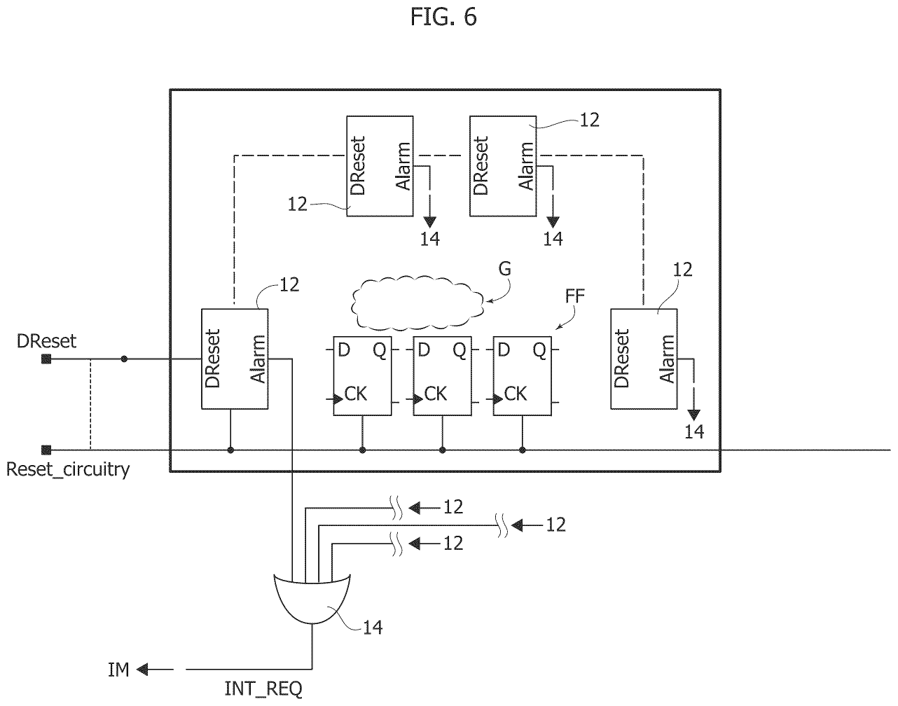

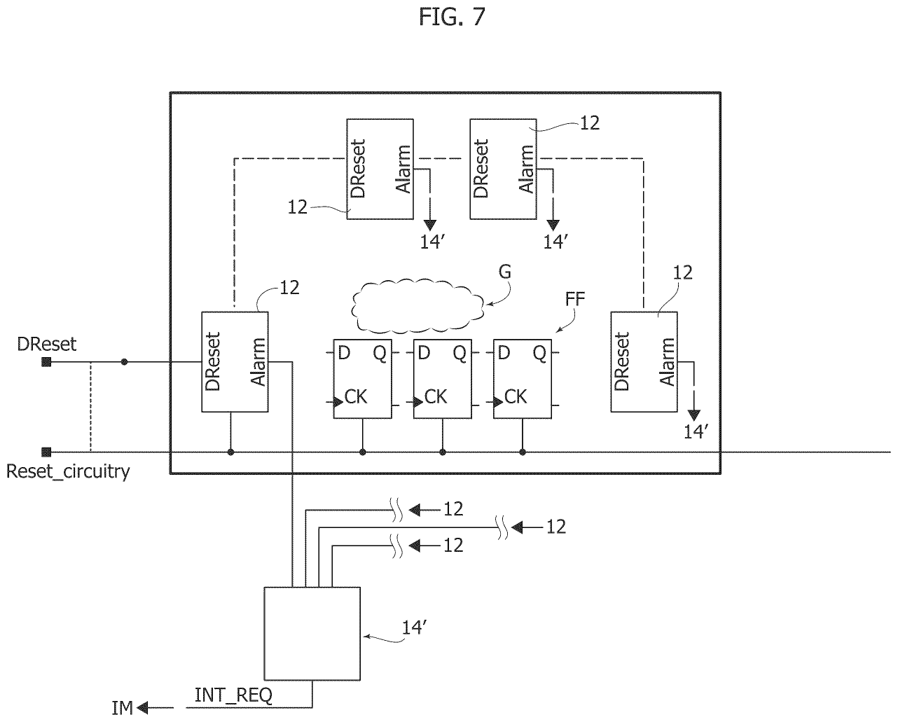

An implementation as exemplified in FIG. 2 is advantageous in so far as it includes only two flip-flops 121, 122 and two logic gates 123, 124 (about 15 gate equivalent) and thus: is suited for standard CMOS implementation, which facilitates placing and routing also in sea-of-gates architectures with a standard flow; involves just two wires (DReset, Alarm) for management, which can possibly be reduced to just one (as discussed in the following in connection with FIG. 6 and FIG. 7, for instance); is essentially self-configured and thus available for direct use by a host without any setup; has low power consumption, which is notionally zero in so far as no runtime trimming or FF pattern changing is involved so that use in thousands is affordable; and can be used at SoC level, with no modification involved in so far as no coordination with the register(s) protected thereby is involved.

A solution as described herein is essentially a static solution operating without any clock or input signal, therefore the solution has no dynamic power consumption, which is advantageous for low power applications. This also provides more flexibility in detector placement since no clock routing or placement considerations are needed.

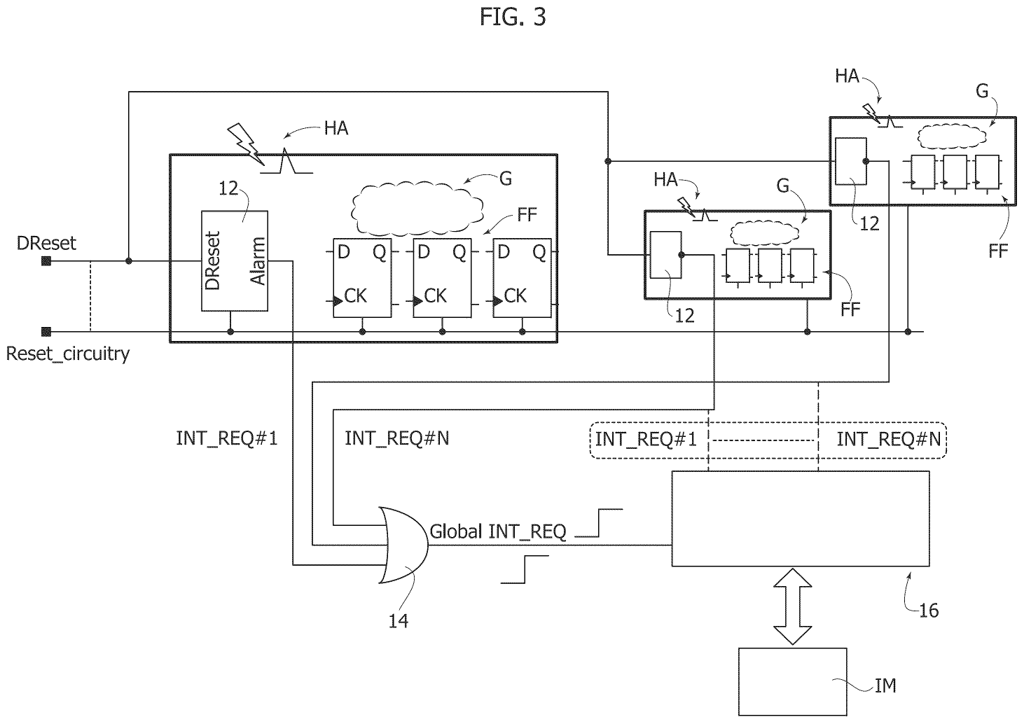

FIG. 3 is exemplary of a first possible implementation of solutions as described herein where a plurality of detectors/sensors 12 as discussed herein are positioned at sensitive areas of a circuit (an integrated circuit, IC such as a system-on-chip, SoC, for instance) intended to be protected against physical hacker attacks.

As discussed previously, solutions as described herein may include a (very) high number (notionally thousands) of elementary detectors 12.

The representation in FIG. 3 (and other figures annexed to this description) is limited to just a few of these detectors (three, for instance) merely for the sake of simplicity and ease of explanation.

The representation in FIG. 3 is primarily intended to exemplify the possibility of locating the detectors 12 at—for instance, in (close) proximity of—portions of a system (a system-on-chip or SoC, for instance) to be protected against localized hacker attacks.

These are attacks that may occur locally, so that the normal functionality of the chip is maintained with the exception of a portion where sensitive information is contained or where sensitive checks are performed.

These portions or areas to be protected are exemplified here as portions or areas where flip-flops FF and logical gates G cooperating therewith are located.

As illustrated herein by way of example, the flip-flops FF may share a common reset line, labeled Reset_circuitry.

The detectors 12 may have reset input lines branching from a base DReset line, while the Alarm outputs from the detectors 12, labeled INT_REQ #1 to INT_REQ #N (here N=3 for simplicity: as noted, N may be a very large number), are fed to the inputs of a logic gate (here exemplified as an OR gate) 14 to generate a resulting “global” alarm signal Global INT_REQ.

As exemplified in FIG. 3, the signal Global INT_REQ is in turn applied to a block 16 configured to manage the alarm signals and facilitate application of suitable measures to counter hacker attacks.

For instance, the block 16 may include a nested vector interrupt control (NVIC) block that facilitates managing the alarm signals in a sophisticated way as interrupt signals (hence the labeling as “INT” signals).

The NVIC block 16 can be configured to co-operate with an interrupt manager feature IM, which is usually already present in a system (SoC, for instance) as considered herein.

Essentially, the NVIC block 16 can be configured (in a manner known per se to those of skill in the art) to differentiate the alarms/interrupts INT_REQ #1, . . . , INT_REQ #N in terms of priority/importance.

For instance, the NVIC block 16 can be configured to facilitate managing interrupts in a flexible manner as desired by a host: for instance, the host (this may be the user of the SoC) may decide that some of these interrupts can be disabled while other interrupts are addressed with a high priority.

That choice can be dictated by the importance of a portion of a system/circuit for a certain application.

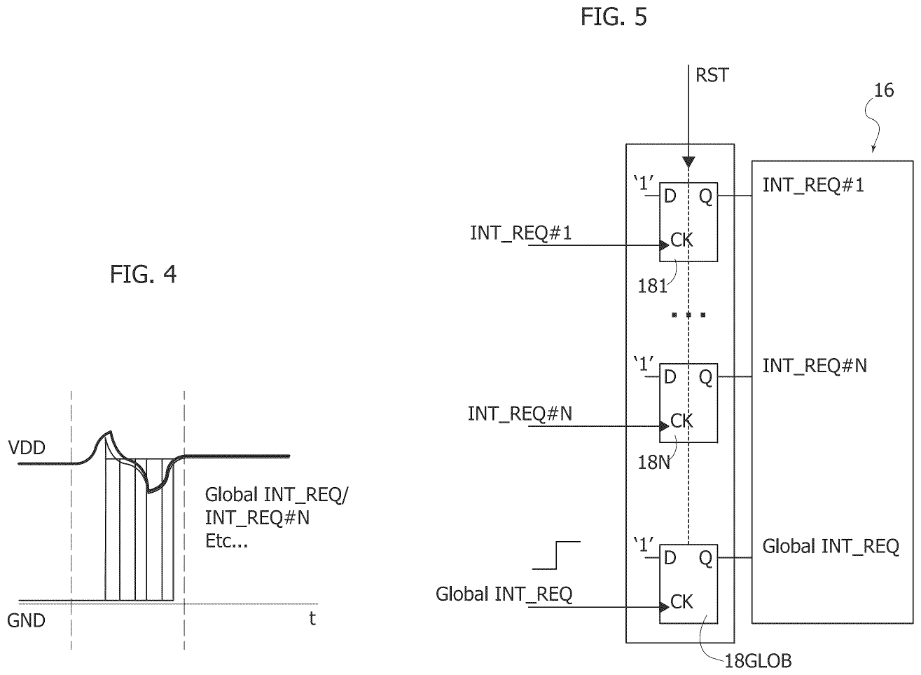

If the NVIC block 16 is located at a distance from the attack point (which is a reasonable assumption) there could be a voltage “bounce” superimposed on the INT_REQ #j (j=1, . . . , N) signal involved as represented by the voltage VDD in FIG. 4, where HA denotes the time over which a hacker attack (LEMA/laser such as LFIA) takes place.

FIG. 4 shows that in the end, an FF-based sensor 12 as represented in FIG. 2 can hold the signal and cause it to be stable enough to be detected on a next NVIC clock cycle.

FIG. 5 is a circuit diagram illustrating possible details of implementations of a solution as illustrated in FIG. 3 where “retention” flip-flops 181, . . . , 18N, 18GLOB are provided for that purpose.

These flip-flops can be provided for each one of the alarm interrupt requests INT_REQ #1, . . . , INT_REQ #N and for the “global” interrupt request Global INT_REQ.

The flip-flops 181, . . . , 18N, 18GLOB share a common reset line RST and have their D inputs set to logical “1”.

They receive the interrupt requests INT_REQ #1, . . . , INT_REQ #N and the “global” interrupt request Global_INT_REQ at their clock inputs CK and deliver corresponding stable interrupt requests (likewise labeled INT_REQ #1, . . . , INT_REQ #N and Global_INT_REQ for simplicity) at their Q outputs to the NVIC block 16.

While represented as separate entities for ease of explanation and understanding, the flip-flops 181, . . . , 18N, 18GLOB may in fact be incorporated into the block 16.

FIG. 6 is a diagram of another possible implementation of solutions along the lines described in the foregoing.

The implementation of FIG. 6 has many points in common with the implementation presented in FIG. 3: for that reason, parts or elements like parts or elements already presented in FIG. 3 are indicated in FIG. 6 with like reference symbols and a corresponding description will not be repeated here for the sake of brevity.

FIG. 6 is exemplary of a possible implementation of solutions as described herein where detectors/sensors 12 are positioned around sensitive areas intended to be protected thereby.

Once again, solutions as described herein may include a (very) high number (notionally thousands) of elementary detectors 12 and the representation in FIG. 6 is again limited to just a few of these detectors (four, for instance) merely for the sake of simplicity and ease of explanation.

The representation in FIG. 6 is primarily intended to exemplify a possible distribution of the detectors 12 where the detectors 12 are arranged around portions of a system (again, a system-on-chip or SoC, for instance) to be protected against localized hacker attacks.

Also in FIG. 6, these portions or areas to be protected are exemplified as portions where flip-flops FF and logical gates G cooperating therewith are located.

As illustrated herein by way of example, the flip-flops FF may share a common reset line (single wire) in a daisy-chain arrangement (with DReset=Reset_circuitry) while the Alarm outputs INT_REQ #1 to INT_REQ #N (here N=4 for simplicity, but N may be again a very large number) are fed to the inputs of a logic gate (here again exemplified as an OR gate) 14 to generate a resulting “global” alarm signal INT_REQ which can be forwarded to an interrupt manager feature IM. As noted, this feature is usually already present in a system (SoC, for instance) as considered herein and, again, can be configured in such a way to manage the alarm signals and facilitate application of suitable measures to counter hacker attacks as discussed previously.

FIG. 7 is exemplary of the possibility of replacing a simple OR gate 14 as illustrated in FIG. 6 with a more sophisticated alarm management network 14′.

Starting from a simple implementation based on an EX-OR gate, such a network 14′ may include a logic network capable of processing alarm signals coming from specific areas/regions of a chip.

For instance, the network can be configured (in a manner known per se to those of skill in the art) to evaluate the magnitude of the attack HA and facilitate a user (implementer) in putting in place countermeasures commensurate with the magnitude of the attack.

For instance, a massive attack (high energy) may “flip” tens of flip-flops FF so that several alarms can be raised and a global system reset can be adopted as a countermeasure in response to such a massive attack.

Conversely, just a few peripheral deactivation/reset interventions can be adopted as a countermeasure in case of a limited attack.

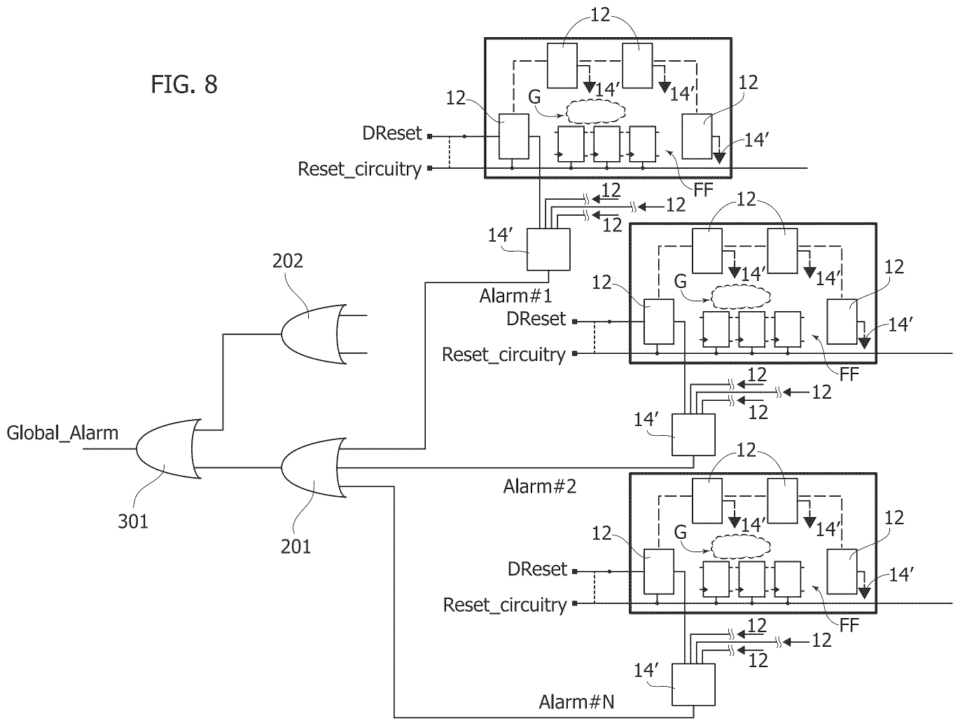

FIG. 8 is exemplary of the possibility of extending to multiple domains the detector placing arrangement exemplified in FIG. 6 (possibly modified as exemplified in FIG. 7): it is noted that such an extension to multiple domains is feasible also for the other detector placing arrangement exemplified herein.

In the case of such an extension to multiple domains, different alarms Alarm #1, Alarm #2, . . . , Alarm #N (once more, N may be a very large number) arising in different regions/peripherals/subsystems can be managed in different ways (for instance as interrupts, as discussed previously) with a few different interrupt lines with alarms possibly collected in groups.

This may occur, for instance, via a combinatorial logic (here exemplified for simplicity as a hierarchical arrangement of layers of OR gates such as 201, 202 and 301, for instance) configured to generate a global alarm signal labeled Global_Alarm from a combination of the individual alarms Alarm #1, Alarm #2, . . . , Alarm #N from various detectors 12.

Whatever the specific implementation details (sensors 12, single/multiple domains, combination of alarms/interrupts, and so on), solutions as described herein facilitate users in implementing countermeasures of their own choice in response to a (maskable) exception raised by hardware detecting an attack.

For example, a user can configure the interrupt manager feature IM in order to implement (enforce) various types of countermeasures against a detected hacker attack such as: keeping a chip under reset up until a source of disturbance disappears; revoking (disabling) the use of some feature/service; launching an erase operation in order to clear sensitive information present in certain registers or memories; and/or requesting user re-authentication once the disturbance disappears.

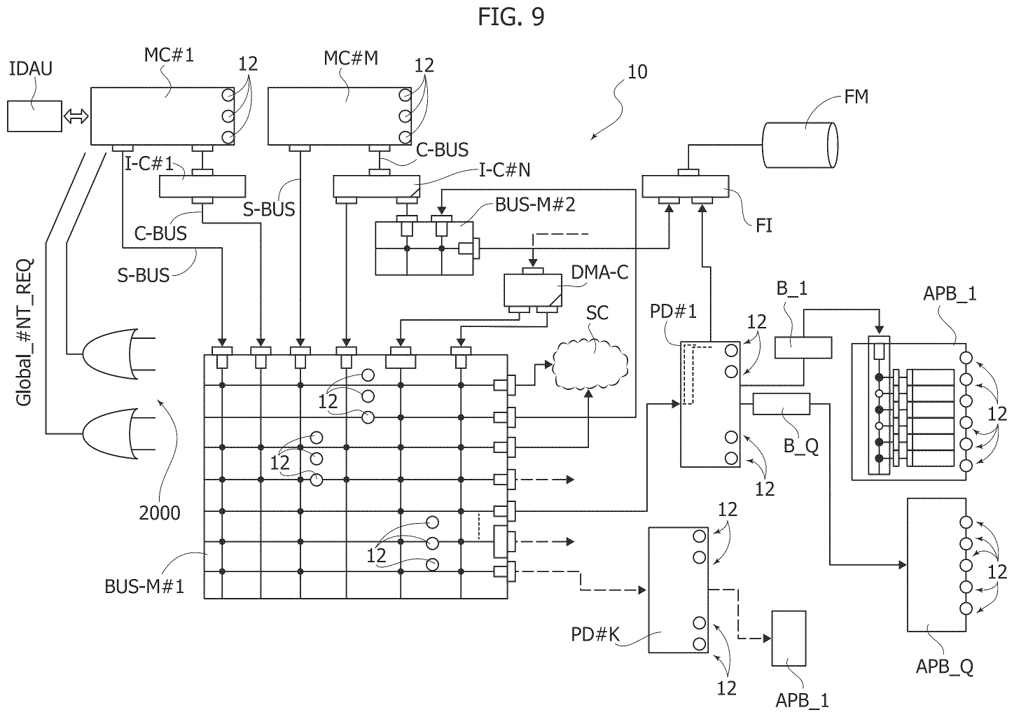

FIG. 9 is a block diagram of multicore system-on-chip (SoC) architecture wherein solutions as described herein can be applied.

Architecture as illustrated in FIG. 9 is exemplary of a variety of systems where a (high) number of detectors 12 (having the structure illustrated in FIG. 2, for instance) can be distributed at various locations where hardware attacks (LEMA or LFIA, for instance) can be attempted.

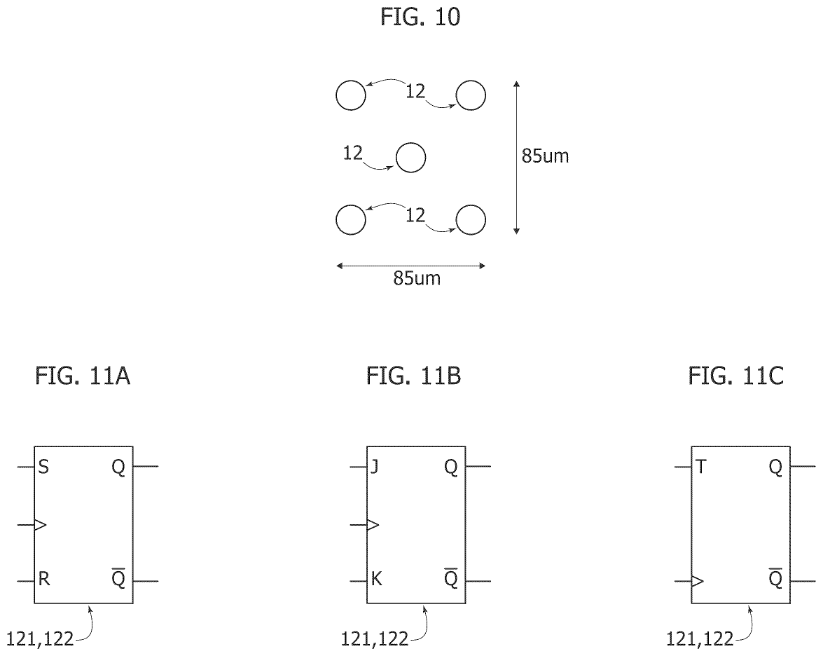

As shown in FIG. 10, detectors (sensors) 12 are distributed, by way of non-limiting example, at:
a number of memory cores MC #1, . . . , MC #M interfacing with an Implementation Defined Attribution Unit IDAU configured to provide address lookups and generate security attributes for the addresses accessed in the memory cores MC #1, . . . , MC #M that have associated cache memories I-C #1, . . . , I-C #M;
a first BUS matrix BUS-M #1 (Advanced High performance Bus—AHB, Advanced Xtensible Bus—AXI or other types) coupled to the memory cores MC #1, . . . , MC #M and the cache memories I-C #1, . . . , I-C #M via buses S-Bus and C-Bus; the first BUS matrix BUS-M #1 co-operates—for instance via a direct memory access (DMA) controller DMA-C configured to facilitate low-latency data transfers between peripherals and memories—with a second BUS matrix BUS-M #2 (again, AHB/AXI/other types) that manages a flash memory FM via a flash interface FI as well as with other system circuitry generally indicated as SC;
various peripheral domains including AHB/AXI blocks AHB1_x/AXI_x, . . . , AHB1_y/AXI_y (labeled PD #1, . . . , PD #K) as well as respective sets of Advanced Peripheral Bus (APB) modules APB_1, . . . , APB_Q coupled therewith via bridges B_1, . . . , B_Q (AHB2APB bridges, for instance).

Again, architecture as illustrated in FIG. 9 is merely a non-limiting example for a wide variety of systems where detectors 12 can be distributed in a (very) large number at various locations exposed to hardware attacks.

FIG. 10 is exemplary of a possible (automatic) uniform placement/positioning of detectors/sensors 12.

This may be with a very high density, for instance with five detectors over a system area of about 7000 um².

This placement may be according to a configuration of staggered parallel rows (oftentimes referred to as “quincunx” configuration) that, as represented in FIG. 10, may be regarded as made up of elementary cells each including four sensors 12 at the corners of a square with sides of 85 μm and a further fifth sensor 12 at the center of the square.

Of course, these quantitative values are merely exemplary and non-limiting: they however bear witness to the possibility of “covering” an IC circuit with a very dense, uniform distribution of detectors 12 each having, for instance, a structure as illustrated in FIG. 2.

This is compatible, for instance, with sea-of-gates architectures with a standard flow such as the TSMC40(G01) 40 nm process available with Taiwan Semiconductor Manufacturing Company Limited.

FIGS. 11A, 11B, and 11C illustrate possible alternative options in implementing the detector presented in FIG. 2.

In FIG. 2, D flip-flops are exemplified for the flip-flops 121, 122 intended to act as sensors to detect hacker attacks HA (LEMA or LFIA, for instance) likely to result in a voltage “bounce” causing flipping of the flip-flop 121 and/or the flip-flop 122.

In fact, any type of flip-flops (FF) or latches can be used for the detectors/sensors 12. For instance, S-R flip-flops (as shown in FIG. 11A), J-K flip-flops (as shown in FIG. 11B), or T flip-flops (as shown in FIG. 11C) can be used in the place of D flip-flops (as shown in FIG. 2).

As is the case of the D-type FFs 121, 122 shown in FIG. 2, these other types of FFs may have their inputs coupled to either a supply node/line VDD or ground (GND), which facilitates increasing the sensitivity to any possible disturbance on VDD or GND.

These different types of flip-flops (D-type flip-flops, S-R flip-flops, J-K flip-flops or T flip-flops, for instance) may exhibit the same sensitivity, but possible flexibility in selecting the kind of FFs used may be advantageous in so far as the same kind of FFs or latches as included in a block to be protected can be used for the detectors/sensors 12 intended to be associated with that block.

Having the same kind of FFs or latches in the detectors/sensors 12 and in the block(s) to be protected thereby facilitates achieving matching therebetween: in fact, in response to including the same kind of FFs or latches, the detectors/sensors 12 can be expected to closely “mimic” the effect of a hacker attack on the portion/area of the circuit/system to which the detectors/sensors 12 are associated.

The ability to design a few kinds of detectors to be disseminated over a circuit/system facilitates using DFT (design for testing or design for testability) techniques to add testability features to a hardware product design.

Distributing over an integrated circuit package a network of elementary detectors may take into account various factors leading to a more refined/effective distribution.

For instance, just a few detectors (or even no detectors at all) can be provided in purely combinatorial areas of the circuit, while conversely the detectors are more densely distributed close to the FF regions (which are detectable by backend tools).

Without prejudice to the underlying principles, the details and embodiments may vary, even significantly, with respect to what has been described by way of example only, without departing from the extent of protection.

The claims are an integral part of the disclosure provided herein in respect of the embodiments.

The extent of protection is determined by the annexed claims.

1. A method of detecting hacker attacks involving voltage variations stimulated in an integrated circuit package, the method comprising:
providing a network of elementary detectors distributed over the integrated circuit package, wherein each of the elementary detectors is arranged at a respective location of the integrated circuit package and is configured to produce an alarm signal in response to a voltage variation occurring at the respective location of the integrated circuit package.

2. The method of claim 1, wherein the network of elementary detectors comprises:
a first component and a second component, each having outputs configured to be set to first logic levels; and
logic circuitry coupled to the outputs of the first component and the second component, the logic circuitry being configured to produce the alarm signal in response to a change in at least one of the first logic levels at the outputs of the first component and the second component.

3. The method of claim 2, wherein the network of elementary detectors comprises:
a first flip-flop and a second flip-flop, each having respective outputs configured to be set to complementary binary levels; and
an OR gate having inputs coupled to:
a logically inverted replica of the output of the first flip-flop, and
the output of the second flip-flop.

4. The method of claim 1, further comprising, in response to at least one of the elementary detectors in the network producing the alarm signal, taking an attack countermeasure selected from the list of countermeasures comprising:
at least temporarily keeping the respective location of the integrated circuit package under reset;
at least temporarily disabling use of the respective location of the integrated circuit package;
launching an erase operation to clear at least part of the respective location of the integrated circuit package; and
requesting user re-authentication.

5. The method of claim 1, wherein the network of elementary detectors comprises flip-flops configured to detect voltage variations by monitoring complementary binary levels at their outputs.

6. The method of claim 5, wherein the network of elementary detectors are configured to generate an alarm signal in response to a change in at least one of the complementary binary levels at the outputs of the flip-flops.

7. The method of claim 6, wherein the alarm signals generated by the elementary detectors are managed by a nested vector interrupt control (NVIC) block configured to prioritize interrupts based on importance of a circuit protected by the integrated circuit package.

8. The method of claim 1, wherein the elementary detectors are distributed in a staggered parallel row configuration, with each detector covering a predefined area of the integrated circuit package.

9. The method of claim 1, wherein the elementary detectors are configured to operate without any clock or input signal, thereby consuming no dynamic power during operation.

10. The method of claim 1, wherein the elementary detectors are configured to detect voltage variations induced by electromagnetic fields or laser beams.

11. The method of claim 1, wherein the elementary detectors are configured to mimic behavior of flip-flops in a circuit protected by the integrated circuit package to achieve matching sensitivity to hacker attacks.

12. An integrated circuit package configured to detect hacker attacks involving voltage variations stimulated in the integrated circuit package, the integrated circuit package comprising:
a network of elementary detectors distributed over the integrated circuit package, wherein each of the elementary detectors is arranged at a respective location of the integrated circuit package and is configured to produce an alarm signal in response to a voltage variation occurring at the respective location of the integrated circuit package.

13. The integrated circuit package of claim 12, wherein the network of elementary detectors comprises:
a first component and a second component, each having outputs configured to be set to first logic levels; and
logic circuitry coupled to the outputs of the first component and the second component, the logic circuitry being configured to produce the alarm signal in response to a change in at least one of the first logic levels at the outputs of the first component and the second component.

14. The integrated circuit package of claim 13, wherein the network of elementary detectors comprises:
a first flip-flop and a second flip-flop, each having respective outputs configured to be set to complementary binary levels; and
an OR gate having inputs coupled to a logically inverted replica of the output of the first flip-flop, and the output of the second flip-flop.

15. The integrated circuit package of claim 14, wherein the first flip-flop and the second flip-flop are selected from D flip-flops, S-R flip-flops, J-K flip-flops, and/or T flip-flops.

16. The integrated circuit package of claim 12, further comprising alarm management circuitry configured to manage alarm signals from the network of elementary detectors distributed over the integrated circuit package.

17. The integrated circuit package of claim 16, wherein the alarm management circuitry comprises a nested vector interrupt control (NVIC) block configured to manage alarm signals from the network of elementary detectors as interrupt signals that are candidates to be disabled or addressed with high priority.

18. The integrated circuit package of claim 16, wherein the alarm management circuitry is configured to take, based on alarm signals from the network of elementary detectors distributed over the integrated circuit package, an attack countermeasure selected from:
at least temporarily keeping the respective location of the integrated circuit package under reset;
at least temporarily disabling use of the respective location of the integrated circuit package;
launching an erase operation to clear at least part of the respective location of the integrated circuit package; and
requesting user re-authentication.
